(19) United States
(12) Patent Application Publication
(10) Pub. No.: US 2002/0083439 A1
(43) Pub. Date: Jun. 27, 2002

(54) System for rescheduling and inserting advertisements

(76) Inventor: Charles A. Eldering, Doylestown, PA (US)

Correspondence Address: EXPANSE NETWORKS, INC., 300 NORTH BROADSTREET, DOYLESTOWN, PA, 18901, US

(21) Appl. No.: 09/742,852

(22) Filed: Dec. 21, 2000

Related U.S. Application Data
(60) Provisional application No. 60/229,156, filed on Aug. 31, 2000.

(51) Int. Cl. H04N 7/025; H04N 7/10; H04N 7/16; H04H 9/00; G06F 3/00; H04N 5/445

(52) U.S. Cl. 725/32; 725/9; 725/42

(57) ABSTRACT

A system for inserting advertisement into channels of media programming are disclosed for improving effectiveness in targeted advertising. The system includes an ad scheduler for identifying a predetermined order in which the advertisements are to be inserted into the channels of media programming. The ad scheduler stores an ordered list corresponding to the identified order and modifies the stored ordered list whenever a modification requiring event occurs. The system further includes an ad insertion module which inserts the advertisements into the programming channels according to the stored ordered list. The system may be implemented at the subscriber's side, e.g., in a set top box or personal video recorder.

### RELATED APPLICATION

This patent application claims the benefit of priority based on U.S. Provisional Application No. 60/229,156, filed on Aug. 31, 2000, owned by the same assignee of the present invention and entitled “Method and System for Addressable and Program Independent Advertising,” which is fully incorporated herein by reference.

### BACKGROUND OF THE INVENTION

1. Field of the Invention

The invention pertains to advertising. More particularly, the invention pertains to targeted advertising, such as in television programming delivery systems utilizing set top boxes for each subscriber.

2. Discussion of Related Art

The traditional paradigm for delivering advertisements (or ads) in the stream of television programming is herein termed linked advertising. Whether the television programming service is being provided by antenna broadcast, analog cable, digital broadcast satellite (DBS), digital cable, switched digital video (SDV) or any other means, generally all viewers of a particular channel will see the same ads in the same order at the same times. In essence, each advertisement is “linked” to a particular point within a particular channel. If any particular viewer is not viewing the particular channel at the particular time, he or she will not see the advertisement. That is, in linked advertising, the advertisements are simply part of the data stream from the head end, i.e., from the head end of the television service provider to all subscribers of that service.

However, with modern digital television service methods, including SDV systems (in which television service is received over the telephone lines) using very high speed digital subscriber line (VDSL), both utilizing the concept of addressable set top boxes (STBs), more personalized service is now available. Further, the service provider can send different data to different subscribers. In telephone based systems such as SDV systems, the service provider can actually send different information to any individual subscriber.

In digital cable systems, such as the Hybrid Fiber Coaxial (HFC) systems used in conjunction with digital set top boxes, it is possible to send multiple versions of a program such that different groups receive different presentation streams. It is possible to present the same programming to each group with different advertisements.

In digital set-top boxes with local storage, also known as Personal Video Recorders or PVRs, it is possible to store advertisements and create unique presentation streams for each user. PVRs can be used in conjunction with a large number of delivery systems including digital cable, Direct Broadcast Satellite (DBS), and VDSL platforms.

Accordingly, it is an object of the present invention to provide an improved method and system for delivering targeted advertising via a network, such as a television service network.

It is another object of the present invention to provide a method and system for inserting targeted advertisements into media program channels at the subscriber's side.

It is still another object of the present invention to provide a method and system for inserting targeted advertisements into television program channels according to the ad insertion schedule.

It is still another object of the present invention to provide a method and system for rescheduling advertisements to be inserted into television program channels when a change in one or more of certain viewing parameters (e.g., channel selection, viewer identity, etc.) occurs.

### SUMMARY OF THE INVENTION

In accordance with one embodiment of the present invention, subscribers to a particular television service provider, such as a cable television network, have set top boxes for accessing television programming channels offered by the television service provider. The set top box for each subscriber is capable of receiving television programming streams or channels carrying programs and openings (or avails). Although the avails may contain default ads, other ads, more suitable to the user, can be inserted.

The advertisements to be inserted into the avails of the incoming programming channels can be stored at the head end or at the subscriber's side such as in the set top box or personal video recorder of the subscriber. The advertisements may also be stored at a remote server on the communications network, as long as the set top box can access the advertisements for insertion into the avails.

The set top box includes an ad processing unit coupled to a display device (e.g., a TV). The ad processing unit determines the next ad or ads to be inserted into the upcoming avails of the programming channel, and the order in which these ads are to be inserted into the programming channel. This determination can be made in advance based on scheduling instructions from the head end system or ad ordering and selection algorithms. The ad processing unit then inserts the ads in the avails as they arrive.

The ad processing unit may also readily change the ad insertion schedule so that the most appropriate ads are actually inserted into the incoming programming channel. Changes in one or more of certain viewing parameters may warrant a change in the ad insertion schedule since the currently scheduled ads may not be appropriate in view of the change in the viewing parameters. Such viewing parameters may include, but are not limited to, channel selection, viewer identity, and the type of program being watched.

The set top box inserts the ads into the incoming programming channel according to the ad insertion schedule, and displays the programming channel with the inserted advertisements on the display device.

Accordingly, the ad rescheduling and ad insertion techniques of the present invention ensure that the advertisements that will most likely interest the current viewer of the programming channel are actually inserted and displayed. This improves the effectiveness of targeted advertising.

### BRIEF DESCRIPTION OF THE DRAWINGS

FIG. 1 is a block diagram of an environment in which the present invention may be utilized.

FIG. 2 is a functional block diagram illustrating advertisement rescheduling and advertisement insertion according to one embodiment of the present invention.

FIG. 3 is a logic diagram illustrating an advertisement queue stored in memory in accordance with the present invention.

FIG. 4 is a pictorial diagram illustrating one example of advertisement rescheduling in the queue in accordance with the present invention.

FIG. 5 is a graphical representation illustrating various models (e.g., orthogonal sponsorship models, linked sponsorship models, hybrid of orthogonal & linked sponsorship models) which may be practiced by the present invention.

FIG. 6 is an example of an advertisement queue which may be used to implement one or more of the various sponsorship models of the present invention.

### DETAILED DESCRIPTION OF THE PREFERRED EMBODIMENTS

In this specification, a “subscriber” includes a viewer, a household, a user, or any entity that has the capability of receiving the advertisements from advertisers according to the present invention. A “subscriber system” is a system at the subscriber's end which receives, processes, and/or displays media signals (e.g., TV Programs) including advertisement signals. Examples of the subscriber system may include, but are not limited to, an entertainment system (e.g., TV, VCR, personal video recorder (PVR), etc.) including or coupled to a set top box or the like, a personal computer, or a computer work station. A “head end system” is a system that originates the media signals and directs them to the subscriber systems. Examples of the head end system may include, but are not limited to, service providers such as a television service provider (e.g., ABC network, a local network), a cable television service provider, a Web TV service provider, a telephone service provider, an Internet service provider, a Direct Broadcast Satellite (DBS) service provider, a wireless television service provider, etc.

The media signals may be communicated between the head end system and the subscriber systems through one or more delivery networks, e.g., two-way cable network, analog cable network, digital cable network, the Internet, Hybrid Fiber Coaxial (HFC) network, switched digital video (SDV) network, DBS network, or wireless network such as MMDS (Multichannel Multipoint Distribution System) or LMDS (Local Multipoint Distribution System). The media signals communicated between the head end system and the subscriber systems can be digital (e.g., MPEG) or analog, and may be communicated in any well known form (e.g., packet data, video streams, etc.).

A preferred embodiment of the present invention will now be described in which the present invention is used to insert advertisements into television programming. However, it should be understood by persons of skill in the art that the invention can be used to insert any data into any other data stream. For instance, the invention can be applied to the Internet, streaming audio data, etc. It also may be applied to insert advertisements in the electronic program guides that are frequently provided in one channel of television programming and which commonly include advertisements in a portion of the display. It is equally applicable to inserting advertisements into recorded data, for example, from a VCR or PVR. Preferably, the information stream includes particular time intervals which are dedicated for insertion of such external data. However, the invention also can be utilized to replace existing data in the data stream, if desired. In the nomenclature of this specification, such designated intervals are termed avails.

In accordance with the preferred embodiment of the invention, various television programming channels or streams include open commercial breaks designated specifically for the insertion of ads by the television service provider. That is, the normal stream of information in the channel includes intervals with default ads (avails) which can be substituted with other advertisements. Alternatively there may be blank intervals so that an advertisement from a source separate from the channel data itself can be inserted into that interval.

In accordance with a preferred embodiment of the invention, the subscriber system has access to a plurality of advertisements which may be provided by the head end system. The subscriber system receives from the head end system or other external source a plurality of programming channels having avails, and inserts selected advertisements into the avails of the programming channels. An ad processing unit of the subscriber system can determine in advance which ads are to be inserted and in what order based on scheduling instructions from the head end system, or predetermined ad ordering and selection algorithms. This ad insertion schedule can be received from the head end (e.g, from the head end over a control channel)and stored in a memory associated with a set top box. Preferably, the ad insertion schedule includes an ordered list of ARLs (advertisement resource locators) each of which indicates the location of a particular advertisement at the head end system or at a separate storage unit where the subscriber system can access the advertisement for insertion into a programming channel.

In accordance with the invention, the ad processing unit is configured to detect any change in one or more of certain viewing parameters associated with the subscriber system. Such viewing parameters may include, but are not limited to, the channel selections made by the current viewer, the identity of the current viewer, the type of program being watched by the current viewer, and the size of the next avail in the current programming channel.

The identity of the current viewer may be determined based on the viewing habits of the viewer. U.S. patent application Ser. No. 09/205,653, filed on Dec. 3, 1998, owned by the same assignee of the present invention and entitled “Subscriber Characterization System”, which is herein fully incorporated by reference, discloses methods and systems for profiling viewers based on their channel changes and other viewing habits.

Based on the detection of the changes in the viewing parameters, the ad processing unit may modify the ad insertion schedule on a on-going, real-time basis so that ads that are most appropriate to the current viewer are inserted and displayed to the current viewer. For example, if the current viewer has just made a channel change, then the ad processing unit may reschedule the ads so that another ad (i.e., ARL for that ad), which would be more appropriate for the newly selected channel, is placed at the top of the ordered list of ARLs for insertion at the next avail. The new ad may be rescheduled in real time without the ARL of the new ad being stored in the queue or the like.

In accordance with the invention, the subscriber system inserts the ads into the incoming programming channel according to the most current ad insertion schedule, and displays the programming channel with the inserted advertisements on a display device such as a TV or computer monitor. This ensures that the advertisements that will most likely interest the current viewer of the programming channel are actually inserted and displayed to the current viewer.

In accordance with one embodiment, the subscriber system includes a set top box operatively coupled to the display device such as a TV. The set top box includes the ad processing unit in addition to the components, such as a CPU, typically found in conventional set top boxes (e.g., for cable TV, DBS, SDV systems). The CPU in the set top box may maintain the ordered list of ARLS in the form of an advertisement queue in memory, e.g., RAM. At a minimum, each ARL may indicate the location of a particular advertisement in the system. Preferably, the ARLs may also indicate other information about the advertisement, such as its length.

The ads that are pointed to by the ARLs preferably are stored in a memory local to the set top box. The local memory for storing the ads may comprise any high volume memory, including, but not limited to, RAM, magnetic hard drive, or optical storage media, such as optical disks. The local memory may be integral to the STB or separately located at a node on a communications network, such as on a remote server. In accordance with the invention, there should be some means by which the set top box or the subscriber system can determine the location and preferably the duration of avails. Several different means for performing this function are possible. For instance, PCT Patent Publication No. WO 99/66719, the disclosure of which is incorporated hereby by reference, discloses several means, such as detecting the black frames which television programmers typically provide in the video stream at the beginning of a television commercial avail. Alternatively, DVS-253 is a digital video standard for television promulgated by the Society of Cable and Television Engineers (SCTE) which provides for digital cue tones within the data stream indicating the start of commercial avails. In an analog television data stream, an avail indicator which can be detected by the set top box can be embedded within the vertical blanking interval. The indicator can include information indicating the duration of the avail.

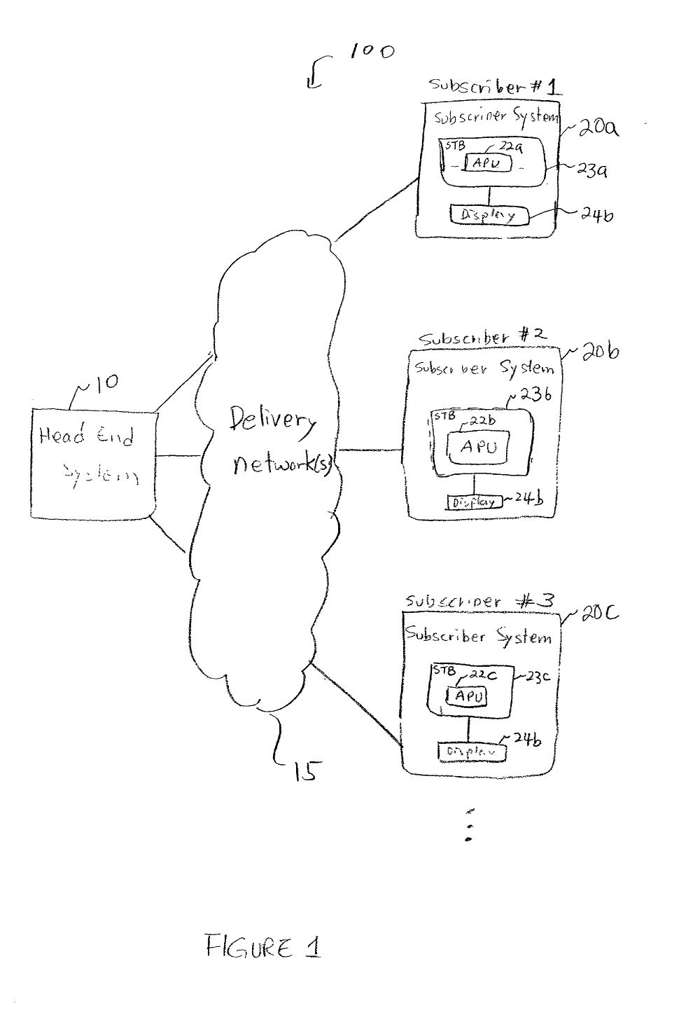

FIG. 1 is a block diagram illustrating an environment in which the present invention may be applied. As shown in FIG. 1, the environment 100 includes a head end system 10 and a plurality of subscriber systems 20a, 20b, 20c (collectively “20”), all operatively coupled through a delivery network 15 such as HFC network, two way cable network, SDV network, DBS network, etc. The head end and subscriber systems and the delivery networks have been discussed above in detail. The head end system 10 generates media signals (e.g., video signals including TV programming streams and/or advertisement signals) and may transmit the media signals to the subscriber systems 20 on a plurality of channels through the delivery network 15.

The subscriber systems 20 receive the media signals from the head end system 10, select and process one or more channels and display them to the subscribers. In accordance with one embodiment, each of the subscriber systems 20 includes a set top box 23a, 23b or 23c, and a display device 24a, 24b or 24c coupled to the set top box. The set top boxes 23 correspondingly include advertisement processing units (APUs) 22a, 22b and 22c, each of which may include an advertisement insertion unit for inserting ads into the incoming channels of media programs. Each of the set top boxes 23 may further include components typically found in set top boxes, such as a tuner, a user interface, a CPU, ROM, RAM, etc. The set top boxes 23 or subscriber systems 20 may include additional memories such as optical disks or magnetic disks.

The system shown in FIG. 1 may be any type of video or data delivery system. In one embodiment, the architecture shown in FIG. 1 may represent a cable system. Although many cable systems are one-way and do not have a network path, many systems have two-way capability, using a Data Over Cable System Interface Spec (DOCSIS) compliant modem to provide return path communications. In the case where a cable system delivery network 15 is a Hybrid Fiber Coaxial (HFC) network, a shared broadcast medium has a tree and branch architecture.

In another embodiment, the delivery network 15 is a switched digital video (SDV) network in which a point-to-point connection is established between the head end system 10 and each subscriber system 20. In the SDV configuration, the point-to-point connections may be established using Very High Speed Digital Subscriber Lines (VDSL), coaxial cables, or a combination thereof. In the SDV configuration, a terminal is typically located in the field and is fed from the head-end via a fiber optic connection.

In another embodiment, the delivery network 15 is a satellite based system such as a Direct Broadcast Satellite (DBS) system wherein video signals are delivered directly to the subscriber systems 20. A return path may be present based on a phone line or other return path.

In the alternative embodiments, other terrestrial wireless networks such as MMDS or LMDS can be utilized to form the delivery network 15.

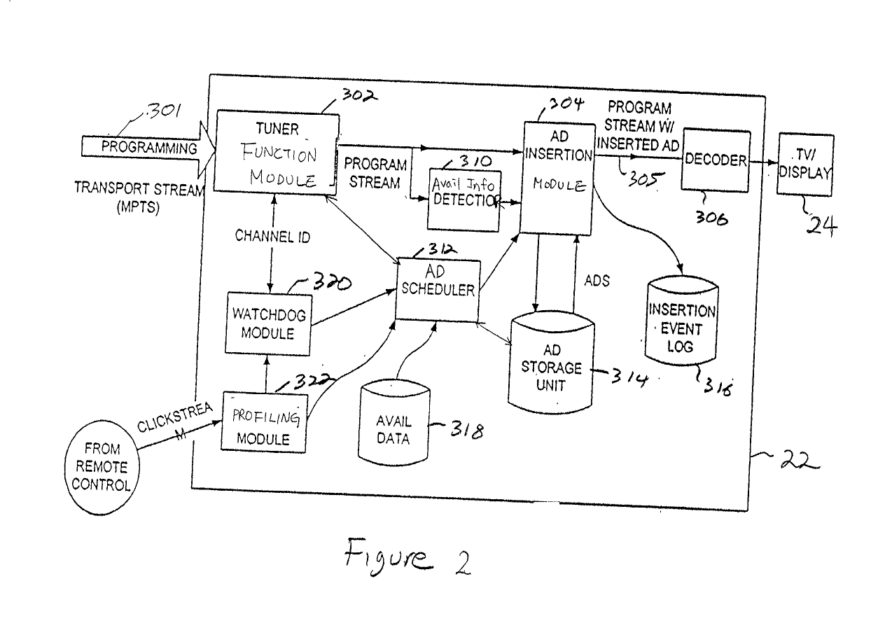

FIG. 2 is an exemplary functional block diagram of the ad processing unit (APU) 22 which may be included in the set top box 23 of the subscriber system 20 according to the present invention. As shown in FIG. 2, the APU 22 may include a tuner function module 302 for receiving at least one programming stream 301, an ad insertion module 304, a decoder 306, an avail information detector 310, an ad scheduler 312, an ad storage unit 314, an insertion event log module 316, an avail data storage unit 318, a watchdog module 320, and a profiling module 322, all operatively connected. The APU 22 is operatively coupled to the display device 24 such as a TV, a computer monitor, etc.

The APU 22 can be realized as a combination of both hardware and software and includes components which are typically used as part of a television set-top including a microprocessor, Random Access Memory (RAM), and in the case of a Personal Video Recorder, a hard drive. The software of APU 22 can be realized in a number of programming languages including C, C++, Java, JavaScript as well as other languages known to those skilled in the art. Many of the elements and modules of the APU 22 can be realized as software running directly on the operating system of the set-top box or on middleware running on the operating system.

In accordance with one embodiment, the avail data storage unit 318 stores therein avail information (e.g., avail size, avail ID, etc.) directed to the avails of the upcoming programming channels, which may be known in advance since avails, such as commercials breaks for TV programs, are predetermined by the TV networks. The watchdog module 320 may determine if there is a change in the program or the type of program being watched by the current viewer. The profiling module 322 may determine if there is a change in the identity of the viewer. The identity of the viewer may be determined using a number of techniques including those disclosed in U.S. patent application Ser. No. 09/452,893, entitled “Subscriber Identification System,” filed on Dec. 2, 1999, which is herein incorporated by reference. The ad scheduler 312 may schedule or reschedule the ad insertion based on the outputs from the avail data storage unit 318, the watchdog module 320 and/or the profiling module 322.

The operation of the ad rescheduling and insertion in accordance with one embodiment of the present invention is as follows. The tune function module 302 receives the programing streams 301 from the head end system 10 or the like. The received programming stream 301 is in the form of a DVB transport stream, i.e. a multiple program transport stream (MPTS), but can be in any other form known in the art. The tuner function module 302 extracts the channel of programs from the MPTS based on the channel selected by the current viewer, e.g., using one or more of tuners, demodulators, and/or demultiplexers.

The channel extracted by the tuner function module 302 carries avail time information (e.g., analog or digital cue tones) which is detected by the avail information detector 310 and indicates the location of an avail in the received program stream. Once the avail is detected based on the avail time information, the advertisement insertion module 304, according to the ad insertion schedule provided by the ad scheduler 312, requests a particular advertisement from the advertisement storage unit 314 which then sends the requested advertisement to the advertisement insertion module 304.

The advertisement insertion module 304 inserts or splices the received advertisement into the avail of the programming stream channel. The resulting program stream channel 305 with the inserted advertisement is decoded by the decoder 306 and sent to the display device 24 for display to the viewer of the display device 24. The seamless splicing of digital videos can be accomplished using a number of techniques well known to those skilled in the art.

The advertisement insertion module 304 generates and stores the advertisement insertion log of all insertion events in the log module 316. This is essentially the schedule of the ads inserted and whether or not they were inserted successfully and/or displayed. The insertion logs will eventually be sent upstream to the head end system to be used for billing advertisers based on the ads that have been played at each subscriber's location.

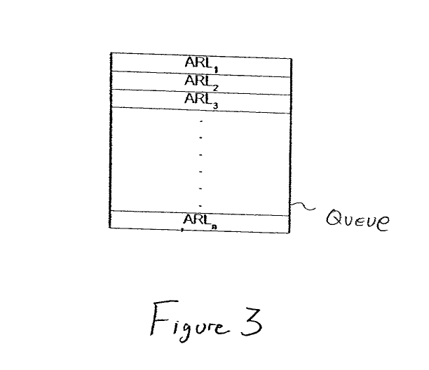

The ad scheduler 312 provides a schedule of ads to be inserted in the form of a queue or other forms. As discussed above, the queue, e.g., as shown in FIG. 3, is a stacked list of advertisement resource locators (ARLs) each indicating the location of a particular advertisement in the system, e.g., in the ad storage unit 314, and other information such as the duration of the stored advertisement. The ad scheduler 31 notifies the advertisement insertion module 304 of either the entire ad insertion schedule or the next advertisement to be inserted according to the ad insertion schedule.

In accordance with one embodiment, the ad scheduler 312 can determine in advance the ad insertion schedule based on scheduling instructions from the head end system 10 or predetermined scheduling algorithms. This can be accomplished as follows. The head end system 10 may transmit the avail information (e.g., timing/duration of upcoming avails, etc.) to the subscriber system 20 for storage in the avail storage unit 318. Based on the avail information in the storage unit 318 and other information (e.g., the time of day, characteristics of the subscriber), the scheduler 312 may prepare in advance the ad schedule in the form of a queue discussed above.

However, the relative appropriateness of the prepared ad schedule may change as circumstances change. Such circumstances may include, but are not limited to, the time of day, program or type of program being watched, channel selection, identity of the current viewer, and timing/duration of the upcoming avail. In the present specification, these circumstances are also referred to as viewing parameters.

In view of the changes in one or more of the viewing parameters, it may be necessary or appropriate to change the ad schedule, some in real time, so that most appropriate ads are actually inserted into the programming streams. For example, the viewer may change the TV channel he is currently watching and the next avail of the newly selected channel may not be of the same size as the next ad in the queue to be inserted. In this case, the ad schedule needs to be changed so that another ad, matching the size of the next avail of the newly selected channel, is moved to the top of the queue for insertion.

In another example, the identity of the viewer may change so that a different person is watching the program. Then, depending on who the new viewer is, the next ad in the queue may not be appropriate to the new viewer (e.g., if the new viewer is a child). In such a case, the ad schedule may be changed so that another ad, which is more appropriate to the new viewer, is moved to the top of the queue for insertion.

In a different example, the type of program or channel being watched may change, so that the next ad in the queue may not be appropriate for the new program or channel being watched. For instance, if the next ad at the top of the queue is for display during a football game on ESPN, this ad may not be most appropriate if the channel is suddenly switched to the Martha Stewart Show on PBS. At this time, the ad schedule change may be needed so that an ad that is more appropriate for display during the Martha Stewart Show can be moved to the top of the queue.

In some circumstances, the ad schedule may need to be changed in real time, such that the newly scheduled ad is inserted immediately into the programming channel without being stored in the queue (e.g., when the newly selected channel is on a commercial break).

The rescheduling of advertisements (i.e., changing the ad insertion schedule) in the queue may encompass reordering the entire list of ARLs, or selectively changing the first or few items on the queue list, which may vary depending on the application. Furthermore, any change in one of the viewing parameters or multiple changes in a combination of the viewing parameters may trigger rescheduling of advertisements, which may also vary depending on the application. For example, the scheduler 312 may be configured to look for changes in both viewer identity and channel selection, before it reschedules the advertisements.

Subscribers can be profiled and an understanding of their viewing/purchase habits can be developed based on their channel changes. Aforementioned U.S. patent application Ser. No. 09/205,653 entitled “Subscriber Characterization System” discusses such schemes. In addition, aforementioned U.S. patent application Ser. No. 09/452,893, entitled “Subscriber Identification System” and owned by the same assignee of the present invention, discloses various methods and systems for determining who is viewing the television based on subscriber characterization. Any of these methods and systems may be used to detect a viewer change that could be used in the present invention as the basis for rescheduling.

In accordance with one embodiment, as discussed above, the scheduler 312 is a real time scheduler so that the rescheduling of ads is performed in real time, i.e., almost simultaneous with the detection of the change in the viewing parameters.

In accordance with one embodiment, the watchdog module 320 looks for the changes to the channel, program, and type of program being watched, and notifies the scheduler 312 of these changes so that the scheduler 312 can reschedule the advertisements, if necessary. For example, the watchdog module 320 may receive from the profiling module 322 information about a channel change made by the current viewer, and identify the new channel currently being watched by the viewer. Further, the watchdog module 320 may identify which program (or type of program) is being watched based on stored program information (e.g., description of programs for different channels, a list of programs to be broadcast for different channels and times of day, etc.).

The watchdog module 320 alerts the scheduler 312 of the recent channel/program change, and the scheduler 312 may determine whether or not such a change warrants rescheduling of the ads in the queue. If it does, then the scheduler 312 reschedules the ads in the queue based on the channel/program change information. If not, no changes are made to the queue. For example, if the watchdog module 320 informs the scheduler 312 that the program change (e.g., from “60 Minutes” to “Dateline”) has occurred, the ad scheduler 312 may determine that rescheduling of ads may not be necessary since the switched programs are of the same program type (i.e., news shows). This determination may be made using stored program information (e.g., a list of programs with assigned program type, ratings, scheduled play time, etc.). However, if there is a change in the type of program being viewed (e.g., from “60 Minutes” to “X-Files”), then the scheduler 312 may reschedule the ads in the queue so that the next ad at the top of the queue is appropriate for display during the showing of “X-Files.”

In accordance with the one embodiment, the profiling module 322 may identify the current viewer of the TV programming channels by processing information such as data from remote control operation through the profiling module 322 (e.g., a volume control and/or channel change control), time of day, and program being watched. By prestoring viewing habits of each viewer in the subscriber household and analyzing the currently receiving viewing habits of the viewer with the prestored viewing habits, the current viewer may be identified. Aforementioned U.S. patent application Ser. Nos. 09/452,893 and 09/205,653 disclose certain methods and systems in accordance with this feature for determining the probable identity or at least characteristics of the particular viewer in a subscriber household that is viewing the television. Other methods of identifying the current viewer may be used. The profiling module 322 outputs the viewer change information to the ad scheduler 312 which uses this information to determine whether to reschedule ads.

It should be understood that the components shown in FIG. 2 represent functional aspects of the APU 22 and that each of these components may be implemented using analog circuits and/or digital circuits, including finite state machines, digital signal processors, computers, central processing units, application specific integrated circuits (ASICs), and programmed general purpose processors.

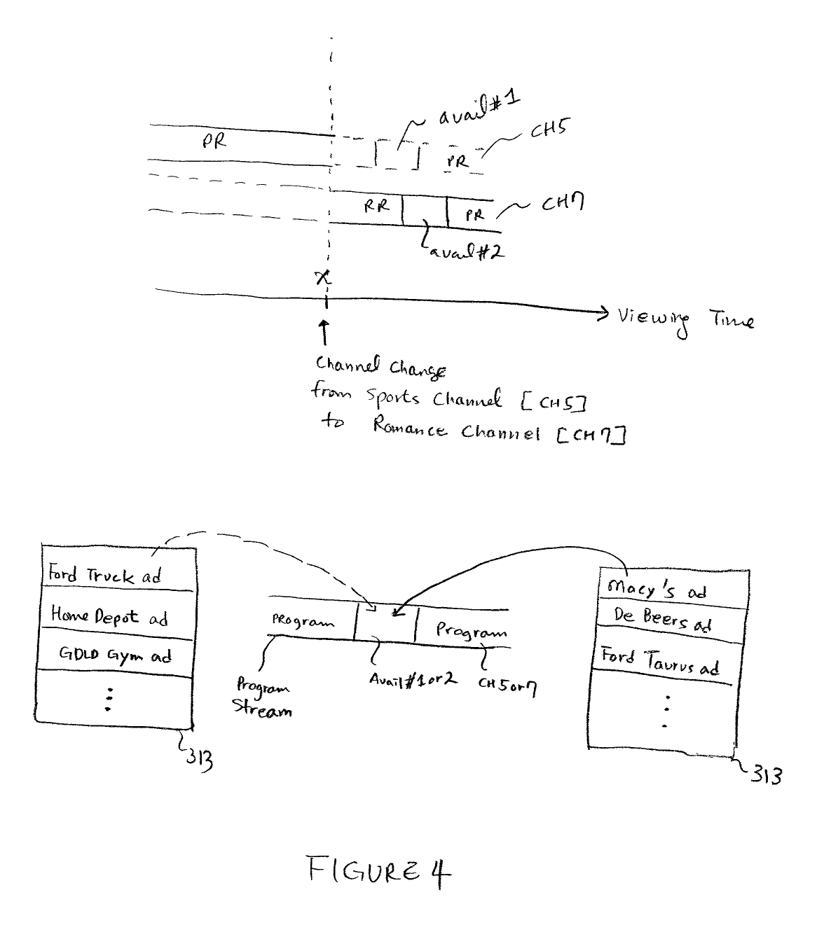

Referring to FIG. 4, one simple example of rescheduling of ads in an exemplary queue according to an embodiment of the present invention will now be described. For this example only, assume that the scheduler 312 has been configured to reschedule the ads upon detection of certain channel changes and that all avails are of the same size. As shown in FIG. 4, the current viewer is watching Sports Channel (channel 5) on cable TV, which includes the next avail labeled “Avail #1.” A queue 313, which may be controlled by the scheduler 312, has an ordered list of ARLs corresponding to the ads (i.e., Ford Truck ad, Home Depot ad, Gold Gym ad, etc.) to be inserted into the upcoming avails in the program streams. When the time comes to insert the advertisement into Avail #1, the Ford ad, which is at the top of the queue 313, will be inserted into Avail #1. However, before this occurs, the current viewer changes the channel to Romance Channel (channel 7) at time X (e.g., 3:02 PM), which includes the commercial break “Avail #2.” At this time, the scheduler 312 determines if rescheduling of ads in the queue 313 is appropriate and reschedules the ads in the queue 313 as discussed above. In this example, the ads which may be more appropriate for showing in Romance Channel (e.g., Macy's ad, DeBeers ad, Ford Taurus ad, etc.) have been selected and placed at the top portion of the queue 313. According to the current ad schedule, the Macy's ad is the next ad to be inserted into Avail #2. In this manner, the rescheduling of ads may occur continuously so that ads that are most appropriate for the current viewer are inserted and played.

In accordance with another embodiment of the invention, the set top box or the subscriber system may maintain multiple queues and execute the viewer determination algorithm for selecting from which queue ARLs will be retrieved based on predetermined criteria. For instance, a different queue may be maintained for each potential television viewer at the subscriber location (e.g., mother, father, child). The algorithm for determining which queue to use to retrieve ads could be based on the identity of the viewer which may be determined by the profiling module 322 as discussed above. If the current viewer is identified to be the mother of the subscriber household, then the queue assigned to the mother may be used to obtain the queued list of advertisements. The scheduler 312 may or may not reschedule the ads in the selected queue in accordance with other changes in the viewing parameters as discussed above.

It will be understood by those of skill in the art that maintaining separate queues is merely an exemplary embodiment and that the invention can be adapted such that there is only one queue, but the ARLs include an additional field that signifies which viewer or type of viewer the advertisement is intended for and that is utilized by the viewer determination algorithm in determining which advertisement will be inserted in a particular avail.

Furthermore, it should be understood by those of skill in the art that the advertisement ordering/rescheduling in the queue may not necessarily be dictated by the physical location of the ARLs in the queue, but can also be dictated by other ordering schemes. For example, one or more tags can be assigned to each ARL in the queue and the advertisement ordering/rescheduling can be dictated based on these tags.

These tags may identify a viewer, a program or type of program, and any other items or events which may be used to order the advertisements. For instance, a viewer tag and/or a program or program type tag may be assigned to each ARL in the queue. Each viewer tag may identify one of the viewers in the subscriber household, e.g., father, mother, first child, or second child. Each program or program type tag may identify the program or the type of program being watched, e.g., sports, news, soap-opera, drama, cartoon, etc. In addition, each ARL may include an identification (ID) tag for identifying the ARL with a serial number or the like. In accordance with one embodiment, the advertisement order in the queue may be dictated based on one or a combination of these tags, e.g., the ID tag, the viewer tag, and the program/program type tag.

One example of how these tags may be utilized to order the advertisements in the queue is now discussed. It should be understood that other examples or modifications thereof are also possible. In the current example, if it is determined that the father in the subscriber household is watching a sports game (e.g., based on the outputs from the watchdog module 320 and the profiling module 322), in accordance with one ordering scheme, the scheduler 312 may look in the queue for ARLs having a viewer tag indicating the father, a program type tag indicating sports, and, of those, an ID tag with the lowest serial number. The scheduler 312 may then retrieve the advertisement based on the located ARL, which is then inserted into the upcoming avail as discussed above.

In accordance with alternative embodiments of the invention, the queue itself need not be stored at the set top box but can be stored at a separate server on the network which communicates with the set top box via the network.

The present invention can also be readily applied to recorded programming as long as the recorded program is played back through the subscriber system so that the advertisement processing unit may insert the advertisements. In fact, the invention can be applied to any information stream regardless of source as long as the information stream passes through the advertisement processing unit. Thus, for instance, the invention is equally applicable to analog cable, regular earth-based broadcast television, the Internet, a read-out from any type of memory device, including compact disks, digital video disks, other optical media, magnetic disks, ROM, RAM, etc.

The present invention can readily be applied to PVRs, which may use a variety of ad insertion opportunities including prepended ads, ads inserted into live programming, ads inserted into recorded programming, ads inserted into content, or ads placed at the end of the programming.

The present invention can also be utilized in Video on Demand (VoD) systems in which advertising plays a role. As with the PVR model, the VoD Systems may utilize ads inserted into the programming, prepended ads, postpended ads, etc.

For the insertion of ads into content, a number of techniques can be utilized including those developed by Princeton Videos Insertion which allow ads to be placed in portions of the programming.

In one embodiment, a service provider (e.g., DBS, cable, SDV, LMDS) allocates and dedicates one or more channels of the head end system to be used for delivering nothing but advertisements and advertisement metadata, including ARLs. This channel could be a high band width (e.g., 6 MHZ) channel. This channel would be encoded and transported in the same manner as any other programming content channel on the head end system and would include all advertisements that are intended for display to any subscriber on the network. The individual subscriber systems can pick out and store the appropriate advertisements and ARLs for subsequent use.

In accordance with the present invention, the rescheduling of advertisements in the subscriber system, e.g., in the queue, may occur in real time, when there is a change in one or more of the viewing parameters, such as channel selection, type of program viewed, identity of the viewer, etc.

The present invention allows targeted ads to be delivered to appropriate viewers without such ads being linked to program/time, so that viewers will always see targeted ads even if they change channels or view programs at different times. This scheme, also referred to herein as “orthogonal” sponsorship model, can be combined, according to the present invention, with the traditional linked sponsorship model to create hybrid orthogonal-linked sponsorship models.

In hybrid orthogonal-linked sponsorship models, the orthogonal sponsorship based queue can be provided with one or more linked sponsorship parameters. Some of these parameters may identify, e.g., time dependence (signifying a specific time), time-of-day dependence (e.g. morning, afternoon, prime time), viewer dependence, or any combination thereof.

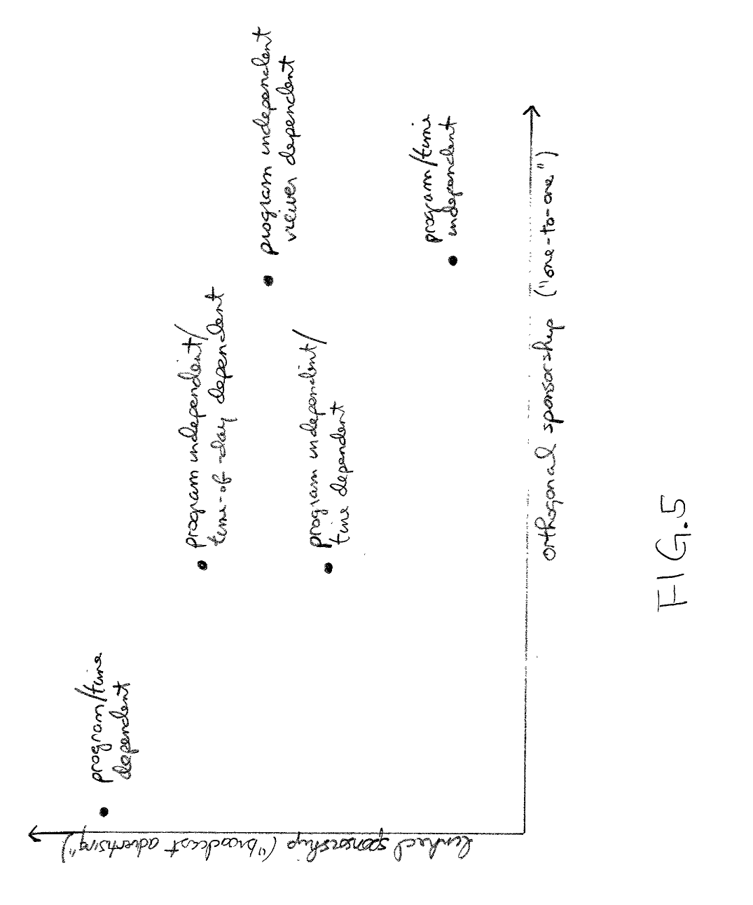

FIG. 5 is a graphical representation for explaining various sponsorship models (e.g., e.g., orthogonal sponsorship, linked sponsorship, hybrid orthogonal-linked sponsorship) of the present invention. The horizontal axis in FIG. 5 represents the orthogonal sponsorship, in which advertisements are displayed regardless of the program/time being shown. The orthogonal sponsorship may be accomplished by inserting advertisements identified by the queue in the next possible avail. The vertical axis represents the linked sponsorship, in which an advertiser purchases a particular avail because it is in a program that has viewers which are of interest to that advertiser.

As shown in FIG. 5, in accordance with the present invention, ads can be delivered to the subscribers or groups of subscribers in accordance with the linked sponsorship model (program/time dependent), orthogonal sponsorship model (program/time independent), and hybrid orthogonal-linked sponsorship models (e.g., program independent/time-of-day dependent, program independent/time dependent, program independent/viewer dependent).

By providing the advertiser the ability to add linked sponsorship parameters to the queue, the present invention allows the use of combination of linked and orthogonal sponsorship parameters, thus providing flexibility to operate between both axes, as shown in FIG. 5.

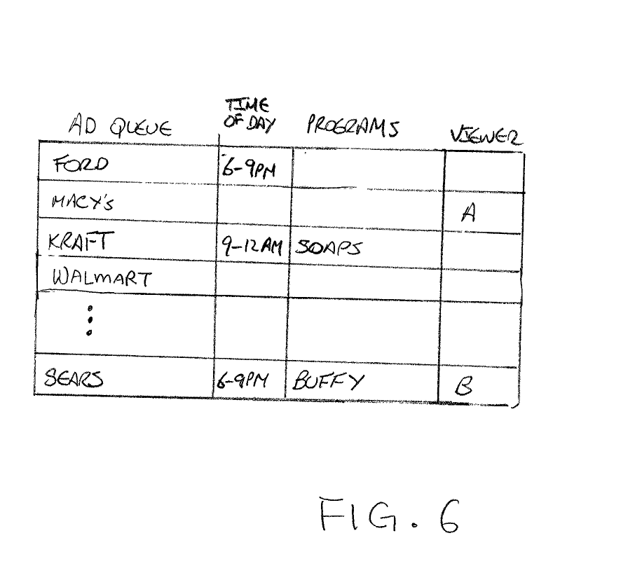

FIG. 6 illustrates an example of an ad queue which may be used to implement the various sponsorship models of the present invention. As shown in FIG. 6, the ad queue can contain additional columns which indicate linked sponsorship parameters such as the time of day, programs in which the advertisement should be shown, and the viewer to which the advertisement should be shown. In one embodiment, when all the linked sponsorship columns are left blank, it indicates that the associated ad may be inserted according to the purely orthogonal sponsorship model, i.e., non-linked advertising. In another embodiment, if any one or more linked sponsorship columns are filled, then it indicates that the associated ads should be inserted into the programming streams according to the hybrid orthogonal-linked model depending on which column is filled.

Accordingly, the present invention ensures that most appropriately targeted ads are inserted into the streams or channels of programming for display to the viewers. Further, it permits ads to be delivered using orthogonal sponsorship and/or hybrid of orthogonal and linked sponsorships, whereby it increases the effectiveness of targeted advertising.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

We claim:

1. A subscriber system for inserting advertisements into at least one channel of media signals, the system comprising:
an ad scheduler for identifying a predetermined order in which the advertisements are to be inserted into the at least one channel, storing an ordered list corresponding to the identified order, and modifying the stored ordered list whenever a modification requiring event occurs; and
an ad insertion module, coupled to the ad scheduler, for inserting the advertisements into the at least one channel according to the stored ordered list.

2. The system of claim 1, wherein the subscriber system is implemented using a set top box and the at least one channel is a television program channel.

3. The system of claim 2, wherein the modification requiring event is at least one or a combination of the following events: a channel change, a viewer change, a change in the type of program being watched, and a change in the size of an upcoming avail in the at least one channel.

4. The system of claim 3, further comprising:
a watchdog module, coupled to the ad scheduler, for detecting a channel change, a change in the type of program being watched and a change in the size of an upcoming avail in the at least one channel, and outputting results of the detection to the ad scheduler, so that the ad scheduler modifies the stored ordered list based on the results of the detection.

5. The system of claim 4, further comprising:
a remote control device for directing to the watchdog module a program channel selection by a viewer, wherein the watchdog module detects the channel change based on outputs from the remote control device.

6. The system of claim 5, wherein the watchdog module detects the change in the type of program being watched based on program information and the channel selection received from the remote control device.

7. The system of claim 5, further comprising:
a profiling module, coupled to the remote control device and the ad scheduler, for receiving viewing information from the remote control device and detecting the viewer change using prestored viewer profile information and the viewing information received from the remote control device.

8. The system of claim 7, wherein the profiling module defects the viewer change using at least one of the following information included in the prestored viewer profile information: volume control information for each viewer in a subscriber household, time-of-day information associated with each viewer, programs watched by each viewer, and channel change information pertaining to each viewer.

9. The system of claim 1, further comprising:
a storage unit, controlled by the ad scheduler, for storing therein the ordered list in the form of a queue.

10. The system of claim 9, wherein the ordered list stored in the storage unit is a stacked list of advertisement resource locators (ARLs) corresponding locations where the advertisements are stored.

11. The system of claim 10, wherein the order in the ordered list stored in the storage unit is dictated by tags included in the ARLs.

12. The system of claim 11, wherein the tags identify one or more of the following parameters: viewer identity, program being watched, type of program being watched, and serial numbers assigned to the ARLS.

13. The system of claim 1, further comprising:
a receiving module, coupled to the ad insertion module, for receiving the at least one channel from a communications network.

14. The system of claim 13, wherein the communications network is a television service network.

15. The system of claims 13, wherein the communications network is an Internet service network.

16. The system of claim 13, wherein the receiving module receives the at least one channel by one of the following means: analog cable, digital broadcast satellite (DBS), digital cable, switched digital video (SDV), digital subscriber line (DSL), very high speed digital subscriber line (VDSL), hybrid fiber coax (HFC) cable, or the Internet.

17. A subscriber system for inserting advertisements into at least one channel of media signals, the system comprising:
first means for identifying a predetermined order in which the advertisements are to be inserted into the at least one channel, storing an ordered list corresponding to the identified order, and modifying the stored ordered list whenever a modification requiring event occurs; and
second means, coupled to the first means, for inserting the advertisements into the at least one channel according to the stored ordered list.

18. The system of claim 17, wherein the at least one channel is a television program channel.

19. The system of claim 18, wherein the modification requiring event is at least one or a combination of the following events: a channel change, a viewer change, a change in the type of program being watched, and a change in the size of an upcoming avail in the at least one channel.

20. The system of claim 19, further comprising:
third means, coupled to the first means, for detecting an occurrence of the modification requiring event, and outputting results of the detection to the first means, so that the first means modifies the stored ordered list based on the results of the detection.

21. The system of claim 20, further comprising:
a channel selection device, coupled to the third means, for selecting a program channel for viewing by a viewer, wherein the third means detects the channel change based on outputs from the channel selection device.

22. The system of claim 20, wherein the third means detects the viewer change using prestored viewer profile information.

23. The system of claim 22, wherein the third means detects the viewer change using at least one of the following information included in the prestored viewer profile information: volume control information for each viewer in a subscriber household, time-of-day information associated with each viewer, programs watched by each viewer, and channel change information pertaining to each viewer.

24. The system of claim 20, further comprising:
a channel selection device, coupled to the third means for selecting a program channel for viewing by a viewer, wherein the third means detects the change in the type of program being watched based on outputs from the channel selection device and program information.

25. The system of claim 17, wherein the first means includes a memory for storing the ordered list in the form of a queue.

26. The system of claim 25, wherein the ordered list stored in the memory is a stacked list of advertisement resource locators (ARLs) corresponding locations where the advertisements are stored.

27. The system of claim 26, wherein the order in the ordered list stored in the memory is dictated by tags included in the ARLs.

28. The system of claim 27, wherein the tags identify one or more of the following parameters: viewer identity, program being watched, type of program being watched, and serial numbers assigned to the ARLs.

29. The system of claim 17, further comprising:
fourth means, coupled to the second means, for receiving the at least one channel from a communications network.

30. The system of claim 29, wherein the communications network is a television service network.

31. The system of claims 29, wherein the communications network is an Internet service network.

32. The system of claim 29, wherein the fourth means receives the at least one channel by one of the following means: analog cable, digital broadcast satellite (DBS), digital cable, switched digital video (SDV), digital subscriber line (DSL), very high speed digital subscriber line (VDSL), hybrid fiber coax (HFC) cable, or the Internet.

33. A method of inserting advertisements into at least one channel of media signals using an advertisement insertion system of a subscriber, the method comprising the steps of:
identifying a predetermined order in which the advertisements are to be inserted into the at least one channel;
storing an ordered list corresponding to the identified order in the advertisement insertion system to produce a stored ordered list;
modifying the stored ordered list whenever a modification requiring event occurs; and
inserting the advertisements into the at least one channel according to the stored ordered list.

34. The method of claim 33, wherein the at least one channel is a television program channel.

35. The method of claim 34, wherein, in the modifying step, the modification requiring event is at least one or a combination of the following events: a channel change, a viewer change, a change in the type of program being watched, and a change in the size of an upcoming avail in the at least one channel.

36. The method of claim 35, wherein the modifying step includes:
detecting an occurrence of the modification requiring event; and
modifying the stored ordered list based on results of the detecting step.

37. The method of claim 36, wherein, in the detecting step, the channel change is detected based on outputs from a channel selection device coupled to the advertisement insertion system.

38. The method of claim 36, wherein, in the detecting step, the viewer change is detected using prestored viewer profile information.

39. The method of claim 38, wherein the viewer change is detected using at least one of the following information included in the prestored viewer profile information: volume control information for each viewer in the household of the subscriber, time-of-day information associated with each viewer, programs watched by each viewer, and channel change information pertaining to each viewer.

40. The method of claim 36, wherein, in the detecting step, the change in the type of program being watched is detected based on outputs from a channel selection device coupled to the advertisement insertion system and program information.

41. The method of claim 33, wherein, in the storing step, the ordered list is stored in a queue in a memory accessible by the advertisement insertion system.

42. The method of claim 41, wherein the ordered list stored in the queue is a stacked list of advertisement resource locators (ARLS) corresponding to locations where the advertisements are stored.

43. The method of claim 42, wherein the order in the ordered list stored in the queue is dictated by tags included in the ARLs.

44. The method of claim 43, wherein the tags identify one or more of the following parameters: viewer identity, program being watched, type of program being watched, time of day, and serial numbers assigned to the ARLs.

45. The method of claim 41, further comprising:
prior to the inserting step, receiving the at least one channel from a communications network.

46. The method of claim 45, wherein the communications network is a television service network.

47. The method of claims 45, wherein the communications network is an Internet service network.

48. The method of claim 45, wherein, in the receiving step, the at least one channel is received by one of the following means: analog cable, digital broadcast satellite (DBS), digital cable, switched digital video (SDV), digital subscriber line (DSL), very high speed digital subscriber line (VDSL), hybrid fiber coax (HFC) cable, or the Internet.

49. The method of claim 33, wherein the ordered list identifies one or more linked advertising parameters for providing linked advertising.

50. The method of claim 49, wherein the linked advertising parameters identify at least one of time dependence, program dependance, and viewer dependence of advertisements.

51. The system of claim 1, wherein the ordered list identifies one or more linked advertising parameters for providing linked advertising.

52. The system of claim 51, wherein the linked advertising parameters identify at least one of time dependence, program dependance, and viewer dependence of advertisements.
